(19) United States
(12) Patent Application Publication
(10) Pub. No.: US 2004/0078228 A1
(43) Pub. Date: Apr. 22, 2004

(54) System for monitoring healthcare patient encounter related information

(76) Inventors: David Fitzgerald, West Grove, PA (US); David Hiebert Klassen SR., Paoli, PA (US); Brian Lucas, Springfield, PA (US)

Correspondence Address: Alexander J. Burke, Intellectual Property Department, 5th Floor, 170 Wood Avenue South, Iselin, NJ, 08830, US

(21) Appl. No.: 10/440,858

(22) Filed: May 19, 2003

Related U.S. Application Data
(60) Provisional application No. 60/384,674, filed on May 31, 2002.

(51) Int. Cl. G06F 17/60

(52) U.S. Cl. 705/2

(57) ABSTRACT

A system monitors in real-time multiple organization patient healthcare financial and clinical encounter related information by automatically recognizing and evaluating complex data patterns to identify statistically significant patterns and clusters using user created data pattern templates to detect fraud, disease outbreaks and cost reduction opportunities. A system monitors healthcare encounter related information derived from patient interaction with a healthcare provider to detect irregular data patterns. The system includes an interface processor for receiving patient encounter related information comprising clinical and financial information from a plurality of different sources for storage in a database. A search processor searches the database to identify a predetermined data pattern and determines whether an identified data pattern meets predetermined criteria. A data processor processes the identified encounter related information to be suitable for output communication.

This is a non-provisional application of provisional application serial No. 60/371,027 by D. Fitzgerald et al. filed Apr. 9, 2002 and of provisional application serial No. 60/384,674 by D. Fitzgerald et al. filed May 31, 2002.

### FIELD OF THE INVENTION

This invention concerns a system and user interface for use in accumulating and monitoring patient healthcare encounter related information to identify data patterns of significance.

### BACKGROUND OF THE INVENTION

Healthcare providers (such as hospitals, clinics or physicians) and other entities, generate records of patient encounters involving patient and healthcare enterprise interaction that have a financial or transaction consequence (such as a patient visit, phone call, treatment, inpatient stay or outpatient procedure, creation of a claim etc.). Such records contain valuable information that may be used for a variety of purposes including detection of medical claim fraud or abuse, detection of disease outbreaks, monitoring incidence of birth defects, detection of bio-terrorism, optimizing clinical system management, optimizing treatments for a particular medical condition, managing healthcare cost, supporting consolidation and merger of healthcare organizations and governmental reporting. Known systems that process patient encounter related data for one or more of these purposes are often inefficient and limited in their capabilities. Specifically, known systems are typically used to process historically accumulated non-real time data and are limited in their scope of applicability, in their flexibility, in their data analysis capability and in the range and nature of the information sources that they are able to examine. Existing systems, for example, are typically constrained to examine particular patient records associated with particular episodes of care that are retained in a local database that is proprietary to a particular healthcare organization in order to recognize particular data patterns for a single purpose.

These limitations mean that existing healthcare claim data fraud detection systems either fail to identify the often sophisticated and complex data patterns indicative of fraud, or detect such data patterns too late to enable prompt or preventive intervention. One system used by healthcare insurance payer organizations, for example, relies on claims surveillance involving analysis and scoring of claim related information in particular databases for subsequent manual review. Such a system, relying on analysis of non-real time historical data, is both incapable of initiating prompt preventive intervention and is vulnerable to human error and also fails to provide continuous 24 hour fraud detection monitoring. Other systems use knowledge-based models for diagnostic interpretation of historical medical data of individual patients to identify and track specific conditions such as diabetes, infection, high blood pressure, food poisoning or other pre-defined conditions, for example. This is done to support patient care, facilitate clinical research or to identify health conditions of public concern. These systems are typically applied retrospectively to limited historical data sets of a single organization. A system according to invention principles addresses the identified requirements and associated problems.

### SUMMARY OF INVENTION

The inventors have advantageously and inventively recognized that it is desirable to provide a system that is capable of deriving insights by advanced real-time analysis of a range of information sources from multiple organizations. These information sources include multi-organization, geographically diverse state, national or international network sources. Such a capability facilitates prompt and accurate detection of incipient widespread medical conditions of public health, environmental or bio-terrorism concern and supports provision of aggregated data and statistical claim (and other) data reports to regulatory and governmental agencies.

A system monitors in real-time multiple organization patient healthcare financial and clinical encounter related information by automatically recognizing and evaluating complex data patterns to identify statistically significant patterns and clusters using user created data pattern templates to detect fraud, disease outbreaks and cost reduction opportunities. A system monitors healthcare encounter related information derived from patient interaction with a healthcare provider to detect irregular data patterns. The system includes an interface processor for receiving patient encounter related information comprising clinical and financial information from a plurality of different sources for storage in a database. A search processor searches the database to identify a predetermined data pattern and determines whether an identified data pattern meets predetermined criteria. A data processor processes the identified encounter related information to be suitable for output communication.

### BRIEF DESCRIPTION OF THE DRAWING

FIG. 1 shows a surveillance and monitoring system, according to invention principles.

FIG. 2 shows an overall encounter data processing system including a monitoring system, according to invention principles.

FIG. 3 shows a flowchart of a process for monitoring healthcare encounter related information to detect irregular data patterns employed by the system of FIGS. 1 and 2, according to invention principles.

FIG. 4 shows a user interface display image illustrating a patient claim billing record for multiple patient encounters with a healthcare provider concerning treatment of an injury, according to invention principles.

FIG. 5 shows a user interface display image illustrating a search template, according to invention principles.

FIG. 6 shows a user interface display image supporting initiation of a search, according to invention principles.

FIGS. 7 and 8 shows user interface display images illustrating status of current and archived surveillance activities for a user, according to invention principles.

FIGS. 9-15 show healthcare encounter related information records accessible by an authorized patient, according to invention principles.

FIG. 16 shows a user interface display image illustrating a user log-on page, according to invention principles.

### DETAILED DESCRIPTION OF INVENTION

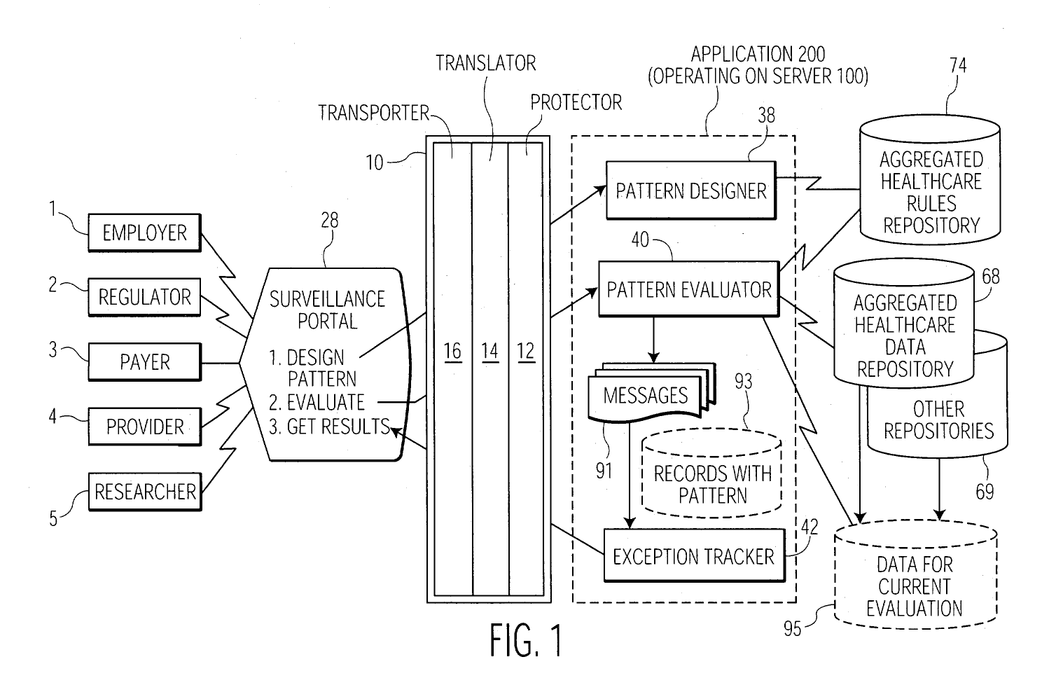

The inventors have advantageously recognized that it is desirable to provide a system for real-time monitoring of patient healthcare financial and clinical encounter related information derived from multiple organizations. FIG. 1 shows a monitoring system for automatically recognizing and evaluating complex data patterns in encounter related information as it is generated, communicated and stored in aggregated healthcare encounter service, billing, and claim data repository 68 of FIG. 1. An encounter as used herein comprises a patient encounter with a healthcare enterprise involving patient and healthcare enterprise interaction that has a financial or transaction consequence and may include for example a patient visit, phone call, inpatient stay or outpatient treatment, an interview, an examination, a procedure, a treatment related occurrence (including imaging, radiology, Electro-Cardiogram (ECG) etc.) an admission to a healthcare enterprise, a test or an order for medication etc. The monitoring system examines encounter related information as it is generated, communicated and stored. For this purpose, the system examines, records and message or stored data associated with orders for services or procedures, test results, laboratory results, billing and claim data, patient records and associated diagnosis, treatment, medication and protocol notes and codes.

A rule as used herein comprises a procedure for determining that healthcare claim elements comply with predetermined requirements including, health plan reimbursement conditions, health plan format requirements, a reimbursement formula, reimbursement constraints and a reimbursement computation procedure. A rule also may comprise a prescribed guide, a precept, or a model for how to present, conduct or regulate an action by using a form and data or the relations between form and data. Further, an exception as used herein encompasses the identification of an issue and mechanism to process that issue and claim elements as used herein may comprise a portion of a claim, a complete claim, individual records of a claim and record data associated with an individual patient encounter with a healthcare service provider. Further, a claim as used herein is an instrument used by insurance companies to recognize services and related changes but it does not create an absolute expectation of payment. In contrast, a bill (typically directed to a guarantor or other fiscally responsible party) is an expectation of payment.

The system automatically and continuously monitors (24 hours a day) real-time messages and communications, as well as the content and associated update messages of data repositories (and not just historical data). The system does this to identify both emerging and long standing statistically significant data patterns and clusters using user created data pattern templates to detect fraud, disease outbreaks and cost reduction opportunities. Complex data pattern templates are employed for detecting data patterns across multiple different types of clinical and financial information derived in real-time from multiple different organizations and sources. The information types include both clinical information types such as orders for procedures and treatments, diagnoses codes, other medical conditions and treatment outcomes, as well as financial information types such as aggregated and collated claim data sorted by diagnoses type, treatment type, organization, responsible physician, geographic region, related medical condition and insurance company. The automatic, real-time continuous data surveillance system advantageously detects and analyzes complex data patterns to identify patterns of statistical significance sufficiently early to enable fraud or disease outbreak prevention or containment whilst eliminating human error.

The FIG. 1 monitoring system identifies single or multiple (cluster) incidents of records matching a template pattern in order to detect fraud, disease outbreaks and cost reduction opportunities. The system separates routine billing patterns from unusual ones by comparing corresponding procedure and treatment costs, utilization rates and treatment outcomes. The system also compares operation profiles of healthcare providers against one another to identify differences in treatment approaches, outcomes, costs, efficacy, medication usage, care plans and working practices. For this purpose, the system searches for systemic patterns of over or under utilization of procedures to treat the patients of an individual provider or practice.

The system identifies cost reduction opportunities benefiting employers, healthcare providers and patients. Thereby, an employer is able to optimize selection of healthcare insurance plans for employees by determining an estimate of employer and employee costs based on real-time interrogation of costs of individual employee care episodes and detect emerging cost patterns and trends. The system identifies disease outbreaks or emergent medical conditions as they develop in an enterprise, multiple organizations at different locations, a geographic region, nationally or internationally or within a particular segment of the population such as pregnant women, children under 10, or people with a related medical condition, for example. The systems is able to monitor morbidity trends, birth defects, chronic conditions and disease outbreaks among a population or among employees or determine if flu, colds, allergies or other diseases are spreading through a workforce in general, or in specific locations or premises. A governmental health agency, for example, is able to confirm outbreaks of disease, food poisoning and other threatening conditions quickly and to circulate the information before illness spreads in order to preempt contagion or intercept delivery of a batch of contaminated food, for example. The system also identifies fraud or abuse in claims made to healthcare payer organizations and fiscal intermediaries (such as healthcare insurance companies or guarantors) by identifying individual suspect claims and systemic patterns of abuse.

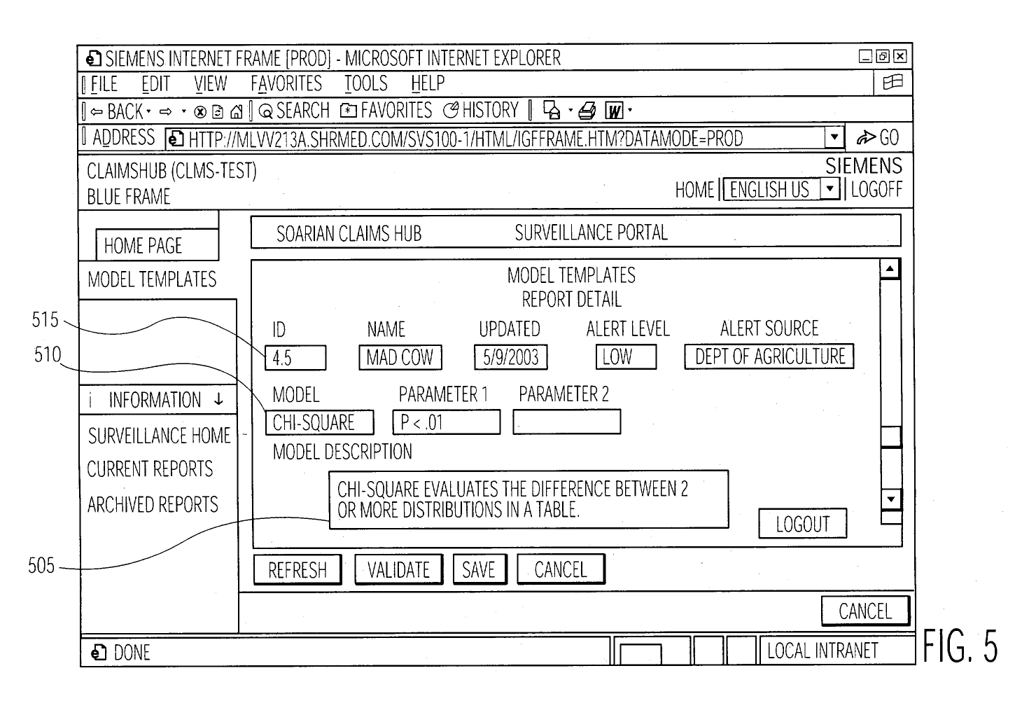

FIG. 1 shows an automatic (24 hour a day operation) monitoring system including pattern evaluator 40 used to search for single or multiple (cluster) incidents of records matching a predetermined template pattern created using pattern designer function 38. The monitoring system searches real-time and historical clinical and financial data sources to detect data patterns indicative of fraud, disease outbreaks and cost reduction opportunities and to collate information for preparation of reports. Historical sources include aggregated healthcare encounter service, billing, and claim data repository 68, rules repository 74 and other repositories 69 including electronic patient record repositories linking treatments and outcomes, for example. Repository 68 comprises at least one relational database linking a record of an encounter resulting in a claim with patient health plan reimbursement and eligibility rules as well as remittance records for a patient medical episode or illness. Repository 68 also accumulates non-redundant data from financial applications of multiple healthcare providers including those of hospital, clinic, and physician systems. Repository 68 uses known techniques to logically link databases residing in multiple locations to link multiple encounters related to care including pre-admission testing, inpatient stay, outpatient follow-up, treatments and outcomes, bills and payments across multiple providers and locations. Similarly, repository 74 comprises at least one relational database including rules used for processing claim data including regulatory guidelines and directives that are continuously acquired and stored in repository 74. Repository 74 also stores rules used to determine whether an identified data pattern meets predetermined criteria by determining whether an occurrence of the identified data pattern comprises a statistically significant occurrence based on predetermined threshold criteria. In addition, repository 74 stores template search patterns for use in repeating a search or for retrieval and amendment to create a new search, for example. FIG. 5 shows a user interface display image illustrating a search template accessible via portal 28. The search template shows on line 515 a search identifier (ID), a search name, a date of last update of search results and an alert level. Further search details are shown in lines 510 and 505 including information identifying evaluation criteria (a Chi-Square criterion in this example) used in evaluating the statistical frequency distribution of derived search results.

A user such as an employer, regulator, healthcare payer organization, healthcare provider organization or researcher (1-5) is able to initiate a search of repository 68, rules repository 74 and other (local or remotely located) repositories 69 using surveillance portal 28 to identify clinical and financial information data patterns. A user is able to search records of repository 68 and other sources to identify data patterns involving data derived from claim update histories and insurance coverage rule update histories, for example. Further, such a search may be targeted to address user determined time periods, or particular periods of elapsed time between events in searching encounter records of individual or multiple individuals. The FIG. 1 system enables accurate and timely access to healthcare encounter related information by providing access to repositories 69 as well as aggregated healthcare encounter service, billing, and claim data in repository 68 in combination with constantly updated rules, regulatory guidelines and directives in repository 74. This is further supplemented by enabling real-time access and searching of data in bidirectional messages being communicated into and out of these database systems and within, hospital, clinic, physician practice (and other healthcare setting) information systems. These bidirectional messages include messages conveying update information to repository 68 in a variety of ways including ANSI (American National Standards Institute) X-12 compatible transactions mandated by HIPAA. Such updates occur in response to X-12 compatible 270 (eligibility request), 271 (eligibility response), 278 (authorization), 837 (claim), and 835 (remit) transactions, for example. Also online updates occur continuously in response to a transaction record being sent from one participant to another, for example. These updates ensure current information is available to a patient or responsible party.

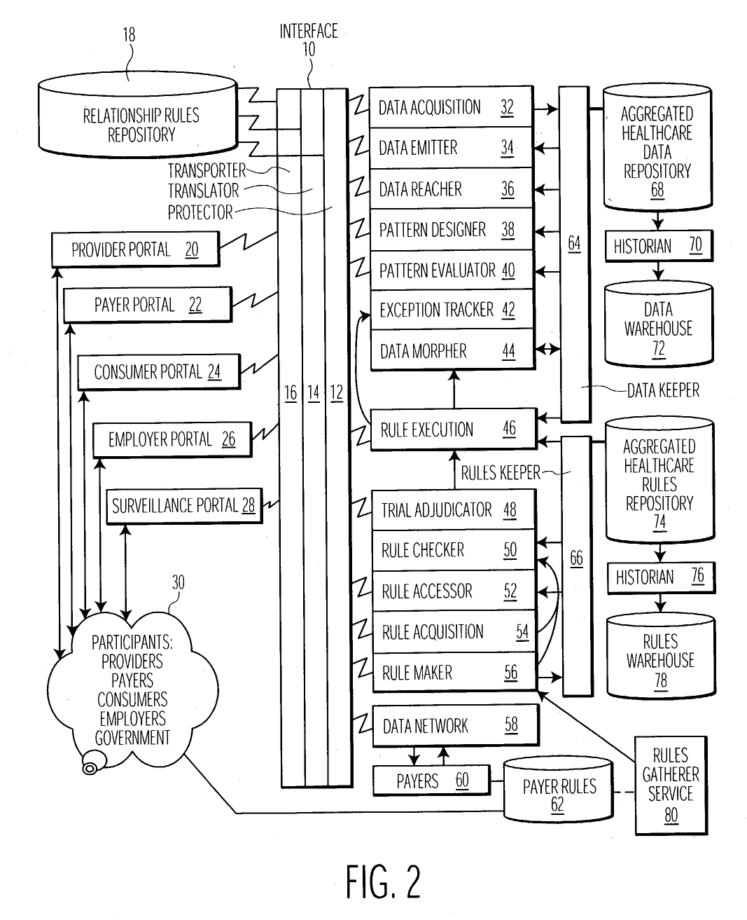

In operation, a user initiates a continuous real-time search of multiple organization and multiple participant repositories exemplified by repositories 68, 69, 74 and repository 18 (shown in FIG. 2 and discussed later) as well as a search of message communications. This is done in response to user command entered using a secured Internet compatible Web based user interface displayed on portal 28 by application 200 executing on a server 100 and conveyed via interface 10. For this purpose, a user accesses pattern creator unit 38 (and functions 40 and 42 as well as messages 91 and records 93) provided by application 200 and server 100 via interface 10 from the user interface of portal 28. A user employs unit 38 to create specialized rules that both determine a template data pattern identifying the scope of data to include in search results and to implement a desired search of data sources to find data matching the template data pattern. The specialized rules govern how often a search is performed and how often search results are to be reported (on demand, periodically, or continuously, for example). The specialized search rules are stored in repository 74. Unit 38 also enables a user to determine a report or output data format that aggregates and collates identified data matching the template data pattern (comprising potentially significant data patterns). Unit 38 further enables a user to review, copy, modify and document existing, stored template data patterns and to generate printed or on screen reports documenting stored search template data patterns.

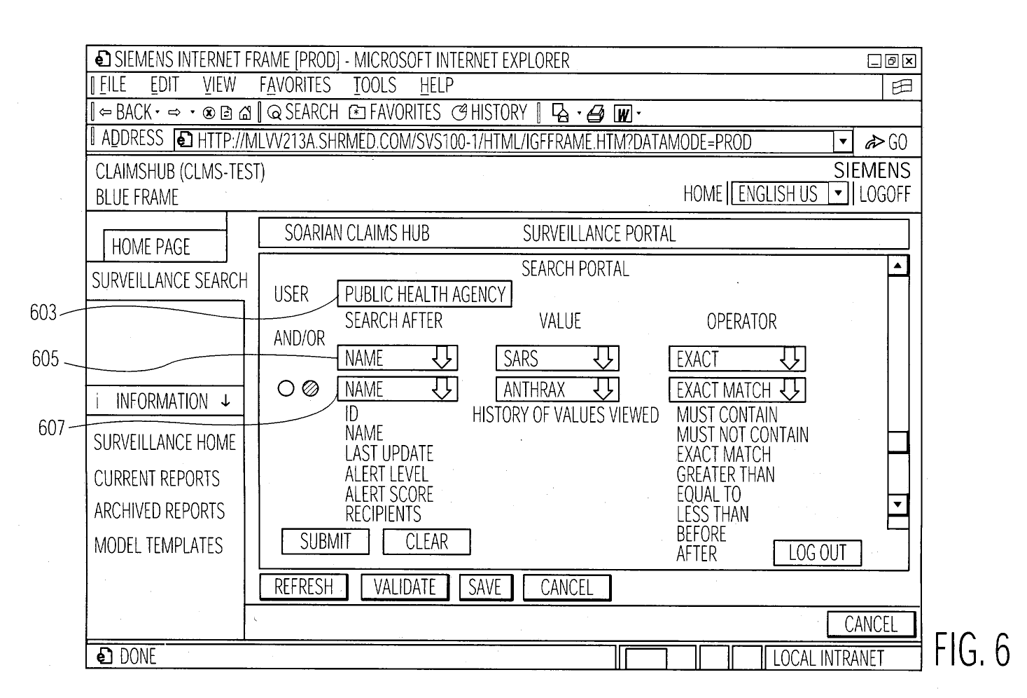

FIG. 6 shows a user interface image displayed on portal 28 supporting initiation of a search for a report concerning a previously performed search. A user identified in box 603 selects search criteria using option list boxes shown on lines 605 and 607. A user employs the first line item to select a data field to be searched from fields including a search identifier (ID), a search name, a date of last update of search results, an alert level and a search report recipient. The user employs the second line item to select the text string or characters to be matched in the selected data field. The user employs the third line item to select the nature of the text string matching to be performed. For this purpose, a user selects an operator from an operator list (including must contain, must not contain, exact match, greater than, equal to, less than, before and after). The illustrated example shows an exact match text search for reports that are named SARS or reports that are named Anthrax.

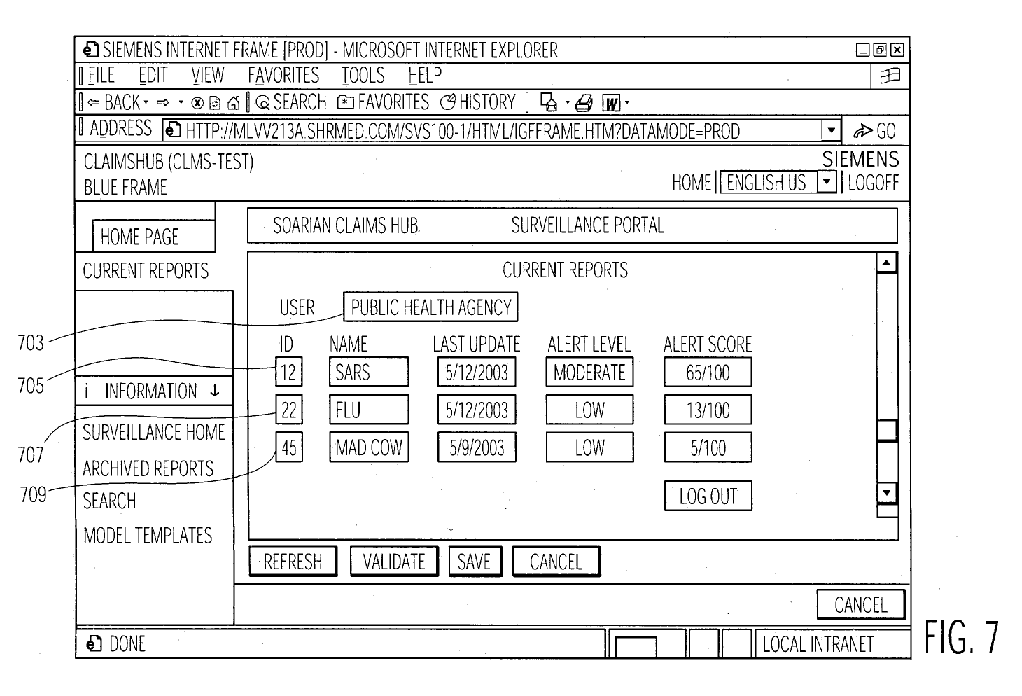

FIGS. 7 and 8 shows user interface display images illustrating the status of current and archived encounter related data search activities for a user. Specifically, FIG. 7 shows three scheduled or continuous searches that are scheduled to be performed or currently underway and identified on lines 705-709 and that are initiated by user 703. A search identification line (e.g., line 705) indicates a search identifier (ID), a search name, a date of last update of search results, an alert level indicating relative importance of derived search results and an alert level indicating on a scale of 100 the degree to which search results match a predetermined criterion used to alert a user. Thereby a user is able to pre-select immediate notification by phone or pager if a score exceeds 90 or by Email if a score exceeds 60, for example. FIG. 8 on lines 805-808 would similarly identify archived (terminated searches) for a user 803.

Pattern evaluator unit 40 initiates a search for single or multiple (cluster) incidents of records matching the predetermined template pattern created using pattern designer function 38 in response to user command entered via the Web compatible interface of portal 28. The search may be scheduled by unit 40 for performance on demand, periodically, at specified times, in response to an event (e.g., upon the receipt of a particular diagnosis report) or continuously or may be discontinued by unit 40 in response to user command. The execution of pattern search rules, like all rules, is event driven. Unit 40 implements a search of identified data sources by repetitively testing portions of data derived from these sources. For this purpose unit 40 copies test data portions into temporary storage unit 95 and compares the copied test data portions against the predetermined template pattern to identify incidents of pattern matches. Identified matching data segments are copied by unit 40 to form corresponding records in temporary storage repository 93. The search results are communicated by unit 40 in messages 91 to exception tracker unit 42. In response to predetermined result format and communication preferences established by a user via portal 28 and implemented as format rules in unit 74, unit 42 aggregates, collates and processes the search result data using the format rules into a desired report format. Unit 42 employs communication interface 10 to deliver the formatted report to a desired destination using a selected communication mode. The formatted report may be delivered using E-mail messages, pager messages, Fax messages, image representative data for on-screen display, printed reports or data formatted to be compatible with an electronic transaction format standard, for example. Unit 42 determines a destination of the formatted report from destination and address information in repository 18 (see FIG. 2) including E-mail addresses, pager numbers, Fax numbers, telephone numbers, Universal Resource Locators (URLs), display addresses and printer location information and transaction recipient address identifiers. Unit 42 also responds to the identification of an exception condition as explained later in connection with FIG. 2.

FIG. 2 shows an overall encounter data processing system incorporating the FIG. 1 automatic (24 hour a day operation) monitoring system. In the FIG. 2 system, the pattern designer 38, evaluator 40 and exception tracker 42 of application 200 are implemented using rule execution unit 46. The FIG. 2 system automates the pre-registration, eligibility, registration authorization, claim generation, trial adjudication, claim submission, payment remittance, and post-remittance processes of a health care claim data processing cycle to provide seamless, accurate and prompt claim processing. A variety of portals 20-26 as well as portal 28 in the FIG. 2 system are controlled and administered by interface 10 to support monitoring of clinical and financial information and to provide claim data access to patients, payers, providers, employers and government agencies. The system facilitates healthcare provider monitoring of compliance with governmental and payer rules through use of automated, rules-based editing and review systems.

The FIG. 2 system comprises functions implemented in software applications and executable procedures for processing claim data. These functions may also be implemented in hardware or in a combination of both hardware and software resident in one or more computer systems and servers and involving one or more communication networks for internal and external communication. The claim data is collated by data acquisition unit 32 via interface 10 for storage in data repository 68. Repository 68 contains aggregated healthcare encounter service, billing, and claim data including financial and clinical data related to healthcare encounters that are currently ongoing. Data acquisition unit 32 is able to receive both solicited and unsolicited data from multiple different sources and to request data from these sources via interface 10. The different sources include external users (participants) subscribing to and using the FIG. 2 system and may include for example, healthcare providers, healthcare payer institutions (e.g. insurance companies, Health Maintenance Organizations—HMOs etc.), consumers, employers, and government agencies. The system processes claim data related to provision of healthcare to a patient by collating data related to a claim for a particular patient for submission to a payer. The collated claim data is submitted for pre-processing using rules to validate the collated claim data is in condition for processing to initiate generation of payment. Upon successful validation the validated claim data is submitted to a payer.

Data keeper unit 64 acts as a gateway and data management system governing data storage and retrieval for healthcare data repository 68 and processing requests to use repository 68 to store, modify, and retrieve data. Historian unit 70 tracks data changes in repository 68 by recording time, date and nature of changes made as well as the source and identity of the author of the changes to maintain a data update audit trial. Historian unit 70 is also used in archiving and maintaining older data value versions and is specifically used in archiving data records associated with patient encounters following completion of financial transactions (i.e. encounters for which no related financial transactions are outstanding) and processing for these encounters. Records of such encounters are maintained by data keeper unit 64 in repository 68. Archiving unit 70 stores archived data in archive (data warehouse) database 72.

The collated claim data is submitted for pre-processing by trial adjudicator 48 using rules to validate the collated claim data is in condition for processing to initiate generation of payment. Trial adjudicator 48 initiates execution of a sub-set of rules executed by rule execution unit 46. Unit 46 detects the occurrence of an event triggering application of associated rules and executes the rules associated with that event. An event may include receipt of data (e.g., a diagnosis report) to add to the repository 68, a request to execute a specified list of rules, a physician order for patient treatment, an emergency or acute care or report, an eligibility request, an eligibility response, a generated authorization, a claim creation, a claim submission, a remittance or request for additional information or an event triggered by the activities of a function within the FIG. 2 system. Unit 46 is also configurable to initiate performance of monitoring using a predetermined template data pattern as described in connection with FIG. 1 upon occurrence of an event. Also a rule executed by unit 46 may itself generate a triggering event and initiate execution of other rules. An individual rule may contain a test resulting in assignment of a result status of “True” or “False” upon execution of a rule. An individual rule may also contain lists of actions to be performed upon a true result and alternate actions to perform upon a false result, for example. The list of actions may include, creation of worklists of tasks for automatic or manual performance, creation of logs and audit reports and accounting reports, creation of error reports, generation of claims, posting of remittances, modification of data, and other actions. Data Morpher unit 44 comprises a sub-category of actions that rules invoke to modify data in repository 68 in response to command. Unit 46 also processes and executes rules stored in the Relationship Rules Repository 18 that contains rules required and used by the Protector 12, Translator 14, and Transporter 16 during communication involving interface 10.

Rules including regulatory guidelines and directives are continuously acquired for storage in repository 74 and are continuously updated and maintained in this repository via rules keeper unit 66. System connectivity rules are also retained in repository 74 and also in relationship rules repository 18 (in support of communication via interface 10). Such connectivity rules support e-commerce communication (e.g., use FTP @ 2400k baud to a certain node name) or determine a communication mode (e.g., prompt a user to e-mail to ask questions or probe a response. Other rules detect inconsistency between data fields such as data fields retaining a telephone number, zip code, address or other geographical identifier of the collated claim data. Rules archiving unit 76 in conjunction with unit 66, dates and time stamps rules to be archived and stores obsolete, expired or older version rules in archive (rules warehouse) database 78. Repository 74 also contains rules developed by the system and by authorized participants that add automated processes to the system.

Unit 48 uses rules in repository 74 derived from external rule sources (such as rules 62 owned by a payer institution 60) by rule accessor 52 via interface 10 and data network 58. Network 58 may comprise a conventional network such a LAN (local area network), WAN (wide area network) or the Internet or alternatively may comprise a network service such as a clearinghouse or other service used by a healthcare payer or a healthcare provider to facilitate data and rule (e.g., payer rules 62) acquisition for claim adjudication. The Rule Maker 56 user interface supports manual creation, review and update of rules including those acquired via unit 54 such as from acquisition service 80. Unit 56 also prompts a user with lists of available tests and actions and guides the user through the process of constructing and editing rules prior to storing the edited rules in Rules Repository 74. Rule Checker unit 50 monitors rules in repository 74 and identifies and indicates to a user those rules that are incomplete or contain incorrect syntax. Unit 50 also reports combinations of rules that are mutually inconsistent. Further, in response to identification of a predetermined exception condition during claim data processing by rule execution unit 46 and trial adjudication unit 48, exception tracker function 42 employs a sub-set of rules managing the processing and reporting of an identified exception condition.

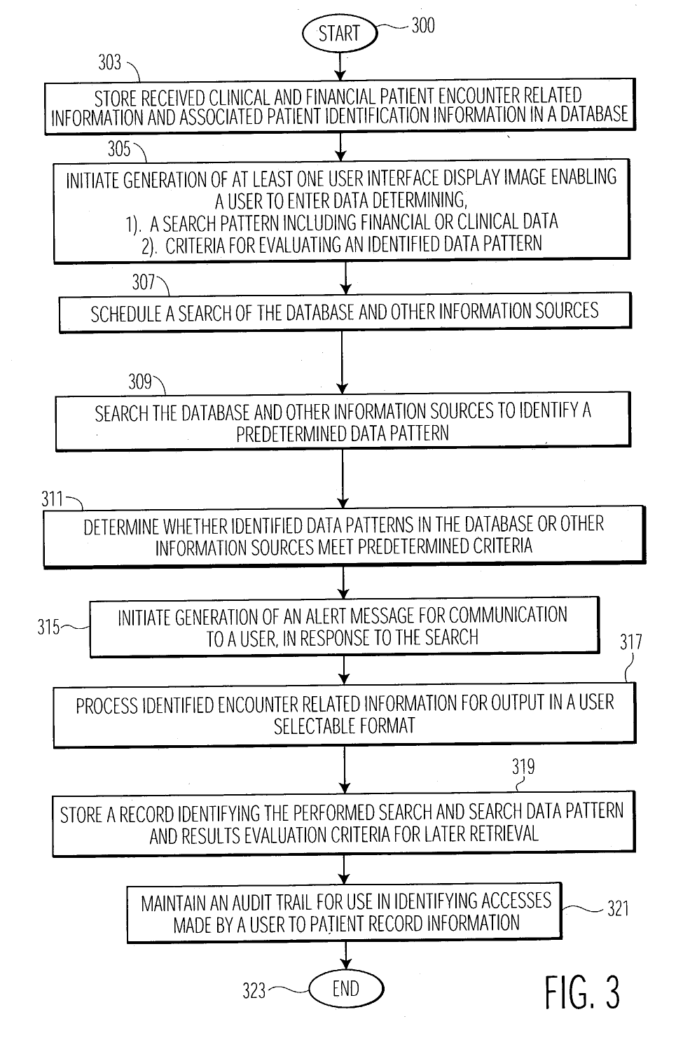

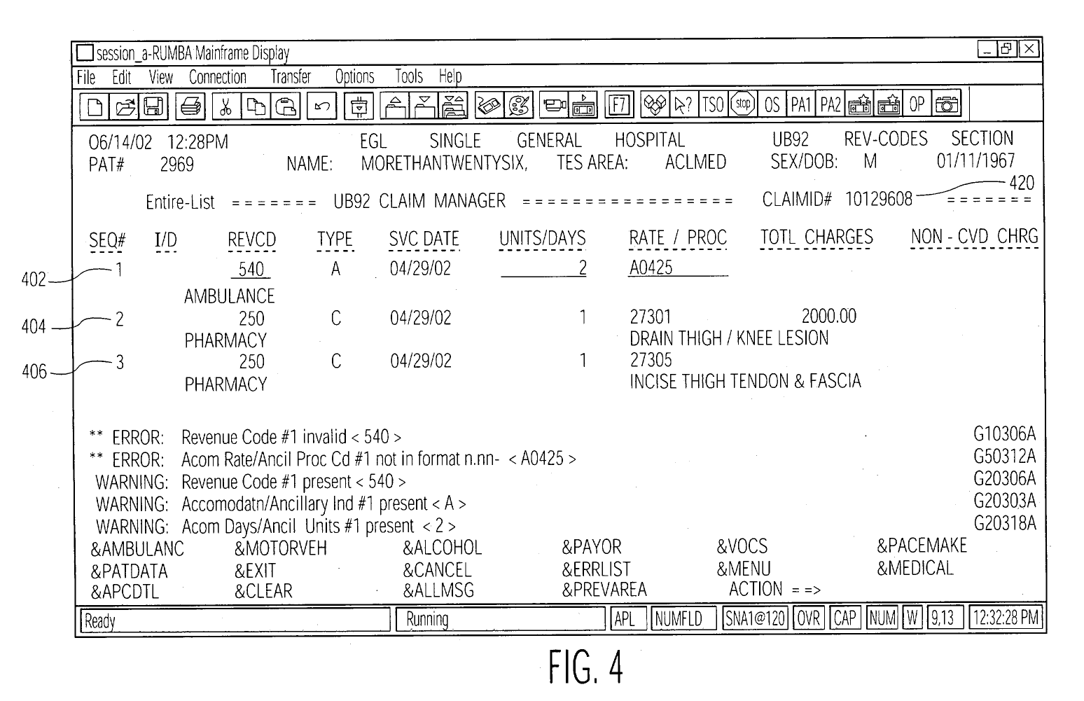

FIG. 3 shows a flowchart of a process employed by the systems of FIGS. 1 and 2 for monitoring healthcare encounter related information to detect irregular data patterns. In step 303, after the start at step 300, application 200 (FIG. 1) acquires patient encounter related information comprising clinical and financial information and associated patient identification information from multiple healthcare provider organizations in multiple different locations. The acquired information is stored in repository 68. The acquired encounter related information includes claim related data, transaction related data, patient hospital admission identification data, payment related data, data representing a request for information, data identifying a medical procedure authorization, clinical data associated with an encounter or data associated with reimbursement denial or acceptance, for example. FIG. 4 shows a user interface display image illustrating an exemplary claim billing record of a particular patient (the patient is identified by item 420). The billing record includes collated claim data for multiple patient encounters 402, 404 and 406 with a healthcare provider concerning treatment of an injury, for example.

In step 303 (FIG. 3), application 200 accesses multiple databases including hospital, clinic, physician or payer databases, for example, to acquire encounter related information for a patient. Application 200 stores the acquired encounter related information in repository 68 by linking a patient identifier with, records identifying patient encounters and data identifying at least one healthcare provider organization associated with the patient encounters and also with a record containing information related to the patient encounters. Repository 74 maintains a map of available remote databases and associated communication data enabling bidirectional communication with available remote databases. Application 200 processes the acquired information to provide collated encounter related information linking a patient identifier with, at least one record identifying multiple encounters, data identifying multiple healthcare provider organizations, data identifying multiple healthcare provider organization associated locations involved in delivering healthcare to a patient, at least one record containing encounter information related to multiple patient encounters, a total cost of multiple encounters associated with treatment of a patient medical condition and treatment eligibility information under a payer health plan applicable to a patient.

Application 200 in step 305 initiates generation of a display image including a data entry element supporting user determination of a data pattern including data associated with both clinical and financial items of a patient encounter record. The generated display image also includes a data entry element supporting user determination of criteria for use in determining whether an identified data pattern meets predetermined requirements. In steps 307 application 200 schedules a continuous search in response to user command. In step 309 application 200 initiates the scheduled search of repository 68, as well as of patient encounter related information being communicated on a communication channel, to identify a predetermined data pattern. Thereby application 200 accumulates data identifying multiple patient encounters matching the predetermined data pattern and stores the accumulated data in repository 93 (FIG. 1).

In step 311 application 200 determines whether the accumulated data in repository 93 meets predetermined criteria by determining whether an occurrence of the identified data pattern comprises a statistically significant occurrence based on a predetermined threshold. Specifically, application 200 determines whether the identified data pattern indicates whether, (a) prescribed medication quantities exceed an expected maximum threshold in a particular period, (b) treatment costs exceed an expected maximum threshold in a particular period, (c) a number of treatments of a particular type are being performed on one or more patients in excess of an expected maximum threshold and (d) payments are being made to a particular patient or physician in excess of an expected maximum threshold. Application 200 also determines whether the identified data pattern meets predetermined criteria by determining whether the number of identified patient encounters exceeds an expected number associated with an expected frequency of occurrence of a particular medical condition. In step 315 application 200 initiates generation of an alert message for communication to a user in response to the performed search. The alert message may indicate, for example, that the number of identified patient encounters exceeds the expected number of identified patient encounters. Application 200 provides the alert message in a user selected format such as in an email compatible format, a phone compatible format, a pager compatible format or a fax compatible format.

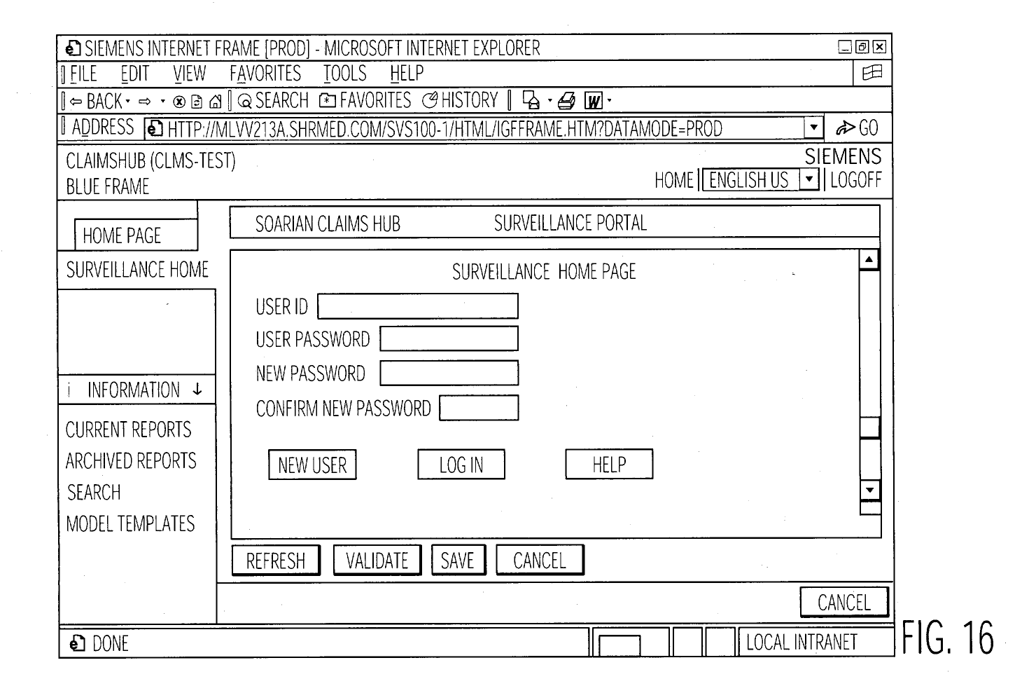

Application 200 in step 317 determines whether a user is authorized to access identified encounter related information in repository 93 in response to received user identification information (comprising a userid and password, for example, or other security or entitlement codes). FIG. 16 shows a user interface display image illustrating a user log-on page supporting user data entry of user identification information received by application 200 for enabling access to portal 28 (FIG. 1) to initiate encounter related data monitoring and surveillance. Application 200 inhibits user access to the identified encounter related information in response to a determination the user is unauthorized to access this information. In another embodiment application 200 inhibits performance of a search in response to a determination the user is unauthorized to access results of such a search. In addition, application 200 also uses the received user identification information to determine whether the user is authorized to access, patient specific encounter related information or patient independent encounter related information. If it is determined that a user is unauthorized to access patient specific encounter related information but may access patient independent encounter related information, application 200 excludes patient specific information (e.g., any information identifying a patient such as name, address, social security number etc.) from results provided to the user. The resultant identified encounter related information is processed by application 200 in step 317 to be suitable for output communication in a user selectable format.

In step 319 application 200 stores a record identifying the search performed previously in step 309 including the search data pattern used and the search results evaluation criteria. In step 321 application 200 maintains an audit trail (e.g., a HIPAA (Healthcare Information Portability and Accountability Act) compliant trail) for use in identifying accesses made by a user to patient record information. The maintained data identifies a user making an access, a source of the access request, the data accessed and associated time and date of access as well as the destination of communicated data). The process of FIG. 3 ends at step 323.

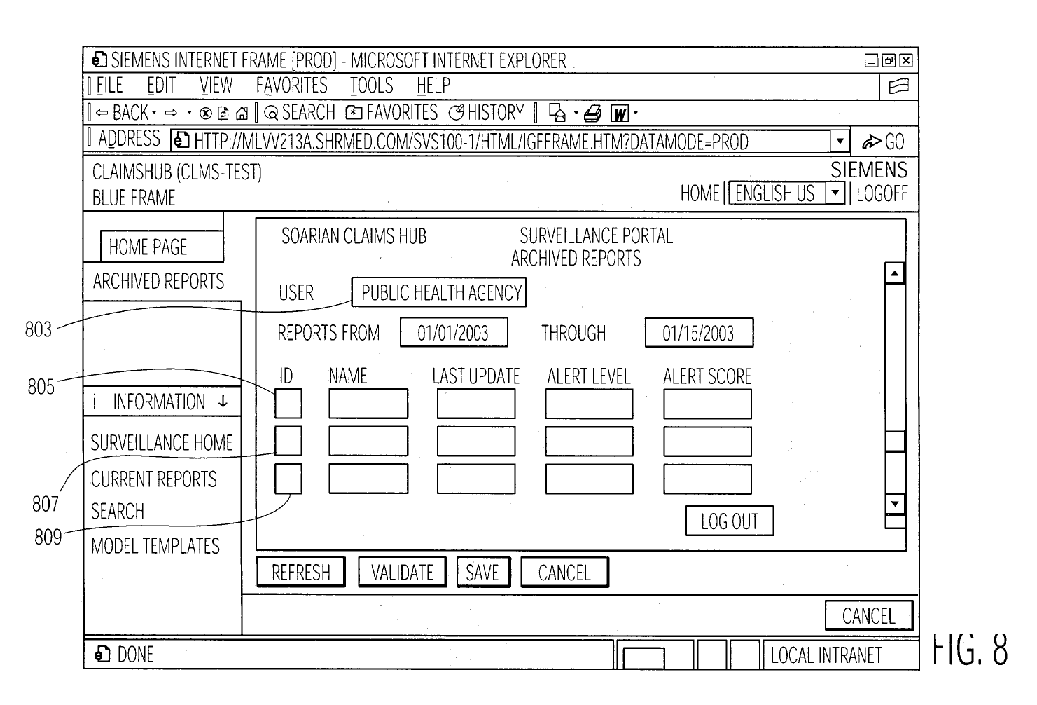

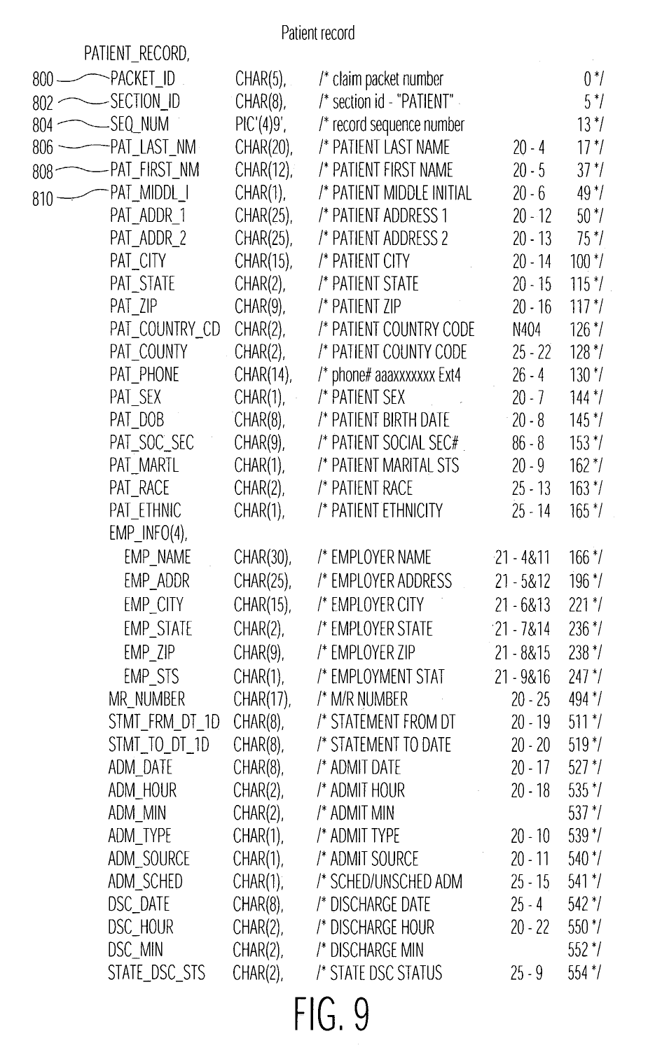

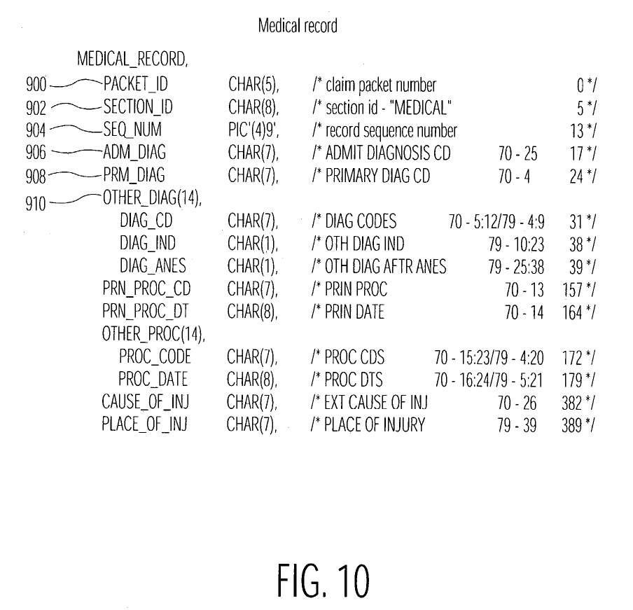

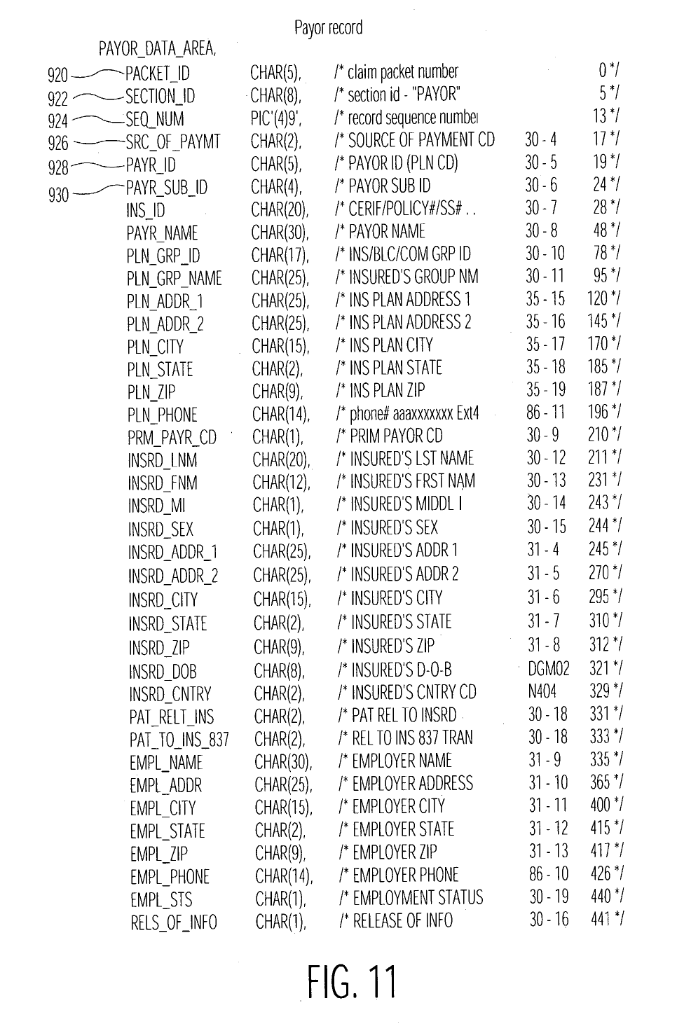

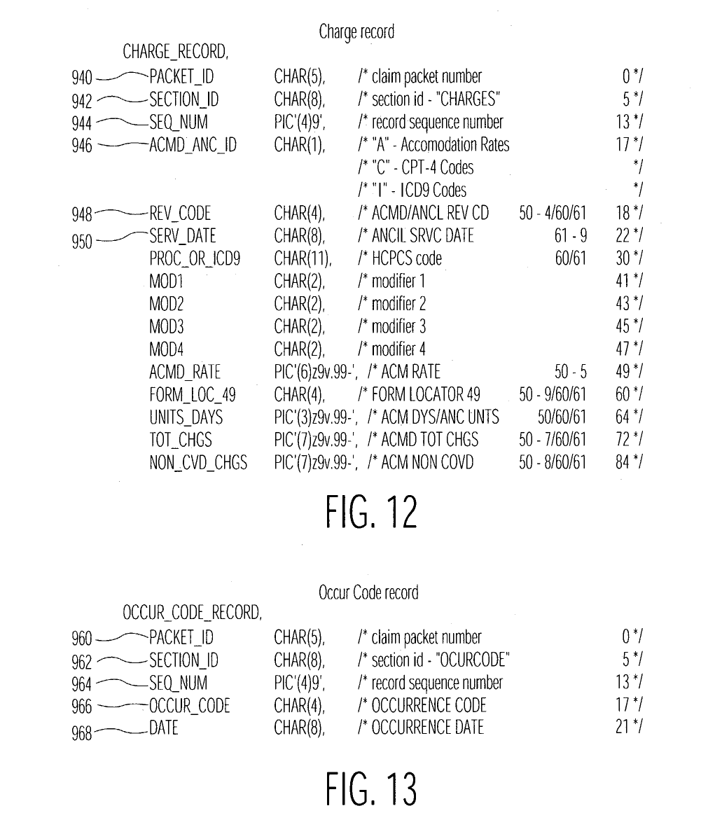

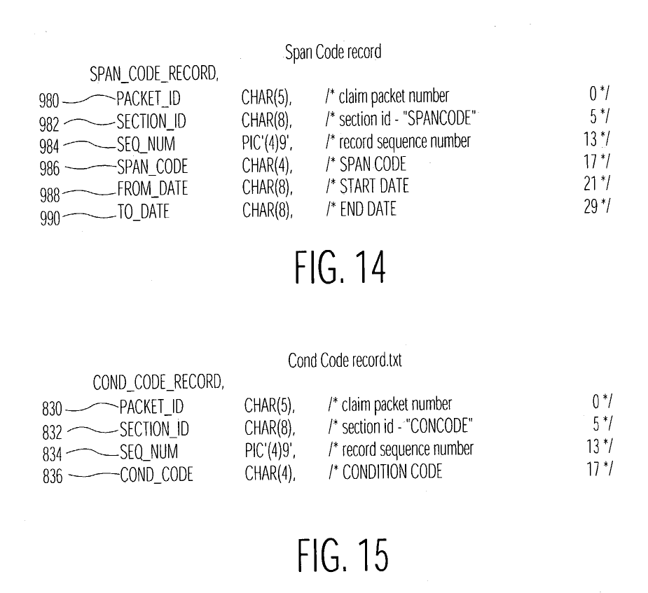

FIGS. 9-15 show healthcare encounter related information as stored in data repository 68. Specifically, FIG. 9 shows a partial patient record data structure, FIG. 10 shows a medical record data structure and FIG. 11 shows a partial payer record data structure. A charge record data structure and occurrence code data structure are presented in FIGS. 12 and 13 respectively and FIGS. 14 and 15 indicate a span code and a medical condition code data structure respectively. A span code is another occurrence code for a clinical or other event that takes place over a period of time. These record structures are exemplary only and repository 68 typically contains other types of records associated with claim data such as, for example, records concerning ambulance services, rehabilitation services, treatments and other services and activities. The record structures of FIGS. 9-15 are individually accessible in repository 68 using a claim packet identifier (800, 900, 920, 940, 960, 980, 830), section identifier (802, 902, 922, 942, 962, 982, 832) and sequence number (804, 904, 924, 944, 964, 984, 834).

Data in an individual record data structure is field length delimited. In the patient record structure of FIG. 9, for example, a patient last name (806) occupies a fixed length of 20 characters, followed by a patient first name (808) occupying twelve characters and middle initial (810) occupying one character. The record structures of FIGS. 10-15 contain data related to other particular claim data aspects in similar predetermined fixed length fields. The medical record of FIG. 10, for example, contains an admission diagnosis code (906), as well as a primary diagnosis code (908) and other diagnosis codes (910). The payer record of FIG. 11 contains a source of payment code (926), as well as payer identifier (928) and payer sub-identifier (930). The charge record of FIG. 12 contains a service charge code (946), as well as a service charge revision code (948) and service date (950). The occurrence code record of FIG. 13 contains an occurrence identification code (966) and occurrence date (968). The span code record of FIG. 14 contains a span identification code (986), as well as a span determination start date (988) and end date (990) for use in identifying a period when the condition defined by the Span Code took place. For example, if a patient has had a similar illness, a span code 986 for that event is coded, and dates 988 and 990 are entered indicating the beginning and the end of the similar illness. In a second example, a span code 986 is used to define eligibility for a particular benefit, such as follow up treatment for 90 days and dates 988 and 990 identify a beginning and ending of the benefit period. The condition code record of FIG. 15 contains a medical condition identification code (836). The items referred to in connection with FIGS. 9-15 are described for exemplary purposes. However, other record items are shown in the record structures of FIGS. 9-12. These other items are representative of the breadth of data that may be included in the various records in the repository 68 structure, for example. In an alternative embodiment, other non-fixed length data record structure or another data record structure may be employed for repository 68.

The healthcare encounter related data in repository 68 (FIG. 2) is collated by data acquisition unit 32 via interface 10 from multiple different sources as previously described and stored in repository 68 via data management system 64. A data emitter unit 34 provides healthcare encounter related data to surveillance portal 28 (or other portals 20-26 for participants 30) by extracting required claim data from repository 68 and communicating it via interface 10. Data reacher unit 36 is used by functions of the FIG. 2 system to provide read-only access to healthcare encounter related data stored by a remote entity and to make decisions based on this data.

Interface 10 provides access by participants 30 to claim data and rule repositories 68 and 74 via portals 20-28 using a security function 12, translator function 14 and transport function 16. Security function 12 determines whether a participant is authorized to communicate with another particular participant and whether a participant is authorized to access particular data and assigns participant privileges and entitlements and maintains security and access rules. Unit 12 rejects and tracks unauthorized requests that violate security and other (e.g., HIPAA) policies. Translator function 14 converts data between the different data formats used by internal and external participants in the FIG. 2 system. For this purpose, translator 14 converts data from a first data format into an internally defined intermediate data format and from the intermediate format into a desired output data format. Transport function 16 supports communication of data and messages between internal functions of the FIG. 2 system and between internal functions and external participants. For this purpose function 16 uses relationship rules repository 18 to identify required connection protocols and methods as well as source and destination addresses. Function 16 also uses rules repository 18 in encoding data in the appropriate message format and protocol and in initiating necessary hand shaking and other routines required to implement bidirectional communication.

Relationship rules repository 18 contains information identifying the application programmer interfaces (APIs) used by participant and system software applications and the required procedure for requesting information from particular sources and providing information to particular participants. The participant API identification and related communication information is provided by individual participants for storage in repository 18. The participants retain control over and maintain their respective communication support information. Interface 10 uses the stored predetermined API and communication information in supporting conversion of data from a first data format into an internally defined intermediate data format and from the intermediate format into a desired output data format. As a consequence, participants are able to update their own systems and to communicate with other participants regardless of the rule standards in use or whether the repositories are migrated to new platforms or radically altered in other ways. Also data format standards involved may be changed by an individual participant without impeding operation by other participants. For this purpose interface 10 uses relationship repository 18 to process the validated claim data to provide the data format, protocol, handshaking routine and submission procedure predetermined (and retained and identified in repository 18) by the payer.

The systems, processes and user interface display formats presented in FIGS. 1-16 are not exclusive. Other systems, processes and user interface forms may be derived in accordance with the principles of the invention to accomplish the same objectives. The inventive principles involve automatically recognizing and evaluating complex data patterns to identify statistically significant patterns and clusters using user created data pattern templates to detect fraud, statistically significant occurrences and cost reduction opportunities and are applicable to the insurance, government and healthcare industries among others.

What is claimed is:

1. A system for monitoring healthcare encounter related information derived from patient interaction with a healthcare provider to detect irregular data patterns, comprising:
an interface processor for receiving patient encounter related information comprising clinical and financial information from a plurality of different sources;
a database for storing said received information;
a search processor for searching said database to identify a predetermined data pattern and for determining whether an identified data pattern meets predetermined criteria; and
a data processor for processing said identified encounter related information to be suitable for output communication.

2. A system according to claim 1, wherein,
said search processor determines whether said identified data pattern meets said predetermined criteria by determining whether an occurrence of said identified data pattern comprises a statistically significant occurrence based on a predetermined threshold.

3. A system according to claim 1, wherein
said identified data pattern indicates at least one of, (a) prescribed medication quantities exceeding an expected maximum threshold in a particular period, (b) treatment costs exceeding an expected maximum threshold in a particular period, (c) a number of treatments of a particular type being performed on one or more patients in excess of an expected maximum threshold and (d) payments being made to a particular patient or physician in excess of an expected maximum threshold.

4. A system according to claim 1, wherein,
said search processor initiates a continuous search of said database to identify said predetermined data pattern, in response to user command.

5. A system according to claim 1, wherein,
said search processor searches patient encounter related information being communicated on a communication channel.

6. A system according to claim 5, wherein,
said search processor initiates a continuing search of said patient encounter related information being communicated on a communication link, in response to user command.

7. A system according to claim 1, wherein,
said search processor accumulates data identifying a plurality of patient encounters matching said predetermined data pattern.

8. A system according to claim 7, wherein,
said search processor determines whether said identified data pattern meets said predetermined criteria by determining whether the number of said identified plurality of patient encounters exceeds an expected number of said identified patient encounters.

9. A system according to claim 8, wherein,
said expected number of said identified patient encounters is associated with an expected frequency of occurrence of a particular medical condition.

11. A system according to claim 8, wherein,
said search processor generates an alert message indicating said number of said identified patient encounters exceeds said expected number of said identified patient encounters.

12. A system according to claim 11, wherein,
said data processor processes said alert message for output, in a user selected format comprising at least one of, (a) an email compatible format, (b) a phone compatible format, (c) a pager compatible format and (d) a fax compatible format.

13. A system according to claim 1, including,
an authorization processor for receiving user identification information and for determining whether a user is authorized to access said identified encounter related information and for inhibiting user access to said encounter related information in response to a determination said user is unauthorized to access said encounter related information.

14. A system according to claim 1, including,
an authorization processor for receiving user identification information and for determining whether said user is authorized to access, at least one of, (a) patient specific encounter related information and (b) patient independent encounter related information.

15. A system according to claim 14, wherein,
in response to a determination by said authorization processor said user is authorized to access patient independent encounter related information and is unauthorized to access patient specific encounter related information, said data processor excludes patient specific information from said identified encounter related information in processing said identified encounter related information for output communication.

16. A system according to claim 1, wherein,
said interface processor acquires patient encounter related information from a plurality of healthcare provider organizations in a corresponding plurality of different locations.

17. A system according to claim 1, wherein,
said data processor processes said identified encounter related information to provide a report for output in a user selectable format.

18. A system according to claim 1, wherein,
said predetermined data pattern includes data associated with both clinical and financial items of a patient encounter record.

19. A system for monitoring healthcare encounter related information, derived from patient interaction with a healthcare provider, to detect irregular data patterns, comprising:
an interface processor for accessing patient encounter related information communications being communicated on at least one of a plurality of communication links from a corresponding plurality of different sources, said patient encounter related information comprising clinical and financial information;
a search processor for initiating a continuing search of said accessed patient encounter related information, in response to user command, to identify a predetermined data pattern and for determining whether an identified data pattern meets predetermined criteria; and
a data processor for processing said identified encounter related information to be suitable for output communication.

20. A system according to claim 19, wherein,
said search processor accumulates data identifying multiple patient encounters matching said predetermined data pattern and determines whether said identified data pattern meets said predetermined criteria by determining whether the number of said identified patient encounters exceeds an expected number of said identified patient encounters.

21. A system according to claim 19, wherein,
said predetermined data pattern includes data associated with both clinical and financial items of a patient encounter record.

22. A method of providing a user interface supporting monitoring healthcare encounter related information derived from patient interaction with a healthcare provider to detect irregular data patterns, comprising the steps of:
generating at least one display image including,
a data entry element supporting user determination of a data pattern including data associated with both clinical and financial items of a patient encounter record,
a data entry element supporting user determination of criteria for use in determining whether an identified data pattern meets predetermined requirements;
searching a database to identify patient encounter related data matching said user determined data pattern;
determining whether an identified data pattern meets said user determined criteria; and
processing said identified patient encounter related data to provide search result information for output.

23. A method according to claim 22, including the steps of
accumulating data identifying a plurality of patient encounters matching said user determined data pattern and
determining whether the number of said identified plurality of patient encounters exceeds an expected number of said identified patient encounters.

24. A method according to claim 23, wherein,
said expected number of said identified patient encounters is associated with an expected frequency of occurrence of a particular medical condition.

25. A method for monitoring healthcare encounter related information derived from patient interaction with a healthcare provider to detect irregular data patterns, comprising the steps of:
receiving patient encounter related information comprising clinical and financial information from a plurality of different sources;
storing said received information;
searching said database to identify a predetermined data pattern;
determining whether an identified data pattern meets predetermined criteria; and
processing said identified encounter related information to be suitable for output communication.

26. A method for monitoring healthcare encounter related information, derived from patient interaction with a healthcare provider, to detect irregular data patterns, comprising the steps of:
accessing patient encounter related information communications being communicated on at least one of a plurality of communication links from a corresponding plurality of different sources, said patient encounter related information comprising clinical and financial information;
initiating a continuing search of said accessed patient encounter related information, in response to user command, to identify a predetermined data pattern;
determining whether an identified data pattern meets predetermined criteria; and
processing said identified encounter related information to be suitable for output communication.
